(19) United States
(12) Patent Application Publication
(10) Pub. No.: US 2026/0352563 A1
(43) Pub. Date: Nov. 5, 2026

(54) ARTIFICIAL INTELLIGENCE MODEL GOVERNANCE BY TAXONOMY

(71) Applicant: DISH Wireless L.L.C., Englewood, CO (US)

(72) Inventor: Matthew Kniess, Lakewood, CO (US)

(21) Appl. No.: 19/195,458

(22) Filed: Apr. 30, 2025

(51) Int. Cl. H04L 41/16; G06F 18/2415

(52) U.S. Cl. CPC H04L 41/16; G06F 18/2415

(57) ABSTRACT

Technologies for providing AI governance via AI taxonomy are described. In one aspect of the present disclosure, a method includes obtaining an indication that first data including metadata is either provided as input to a first AI model or generated as output from the first AI model. The method further includes determining, based on the metadata, that the first data belongs to a first classification. The method further includes determining, based on an AI taxonomy scheme, that the first AI model is not to be utilized in connection with the first classification. The method further includes performing a corrective action based on the AI taxonomy scheme and the first classification

### BACKGROUND

Telecommunication networks, such as cellular networks, have various resources that produce data and metadata concerning operations of the cellular network. A customer, such an enterprise customer, of a cellular network does not have access to the data and metadata generated by the network resources of the cellular network. Status reports, including error codes, may be generated which are indicative of deficiencies in operations of the network. Patterns in data passing through the network, including traffic behavior, may further be indicative of various network operations or potential improvements. Often, various artificial intelligence (AI) or machine learning (ML) models may be used in a network, which may also not be accessible to those that may benefit from and be entitled to additional information related to network traffic in the workings of the network.

One type of cellular network is a Fifth generation (5G) wireless network. In a 5G wireless network, a 5G Standalone Core Network (5G SA core) is responsible for managing and routing data traffic, providing various network resources and services, and supporting the core functionalities of a 5G network. The term “SA” stands for “Stand-Alone,” indicating that this core network operates independently of any existing 4G (LTE) infrastructure. 5G wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic. Control plane logic may also identify packets to be discarded and packets to which a high quality of service should apply. 5G wireless user equipment (UE) may communicate over both a lower frequency Sub-6 GHz band between 410 MHz and 7125 MHz and a higher frequency mmWave band between 24.25 GHz and 52.6 GHz. As described above, various resources and services of the 5G wireless network are not accessible to a customer for optimizing usage and configuration of these resources in a meaningful and insightful way.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of an AI governance system, including an AI governance function, according to some embodiments.

FIG. 2 shows an illustrative system corresponding to an Open Radio Access Network (O-RAN) architecture with AI governance function according to at least one embodiment.

FIG. 3 depicts a cellular network including a radio access network and a core network configured to utilize taxonomy and classification for AI governance, according to some embodiments.

FIG. 4 depicts a radio access network and a core network for providing a communication channel between user equipment and a data network, including an AI governance component, according to some embodiments.

FIG. 5 illustrates a model training workflow and model application workflow for cellular network data in connection with AI governance operations, according to some embodiments.

FIG. 6 is a flow diagram of a method associated with operations of AI governance functions, according to various embodiments.

FIG. 7 is a block diagram illustrating a computer system, according to some embodiments.

### DETAILED DESCRIPTION

Technologies for providing monitoring and governance of data provided to, consumed by, and generated by artificial intelligence (AI) models in complex computing and data delivery environments, such as a telecommunications network or cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There are new and emerging applications with time sensitive features that could provide significant improvements to operations of a data delivery environment, such as a wireless network. In particular, AI-based solutions, including autonomous and semi-autonomous AI that may be authorized to engage in actions such as data delivery with little oversight, may be used to improve technical, business, and other aspects of operations of a network. However, some data may be undesirable or inappropriate for use with some AI models. For example, use of some data for AI may express an unwanted bias or undesirable ethic, use of some data for AI may present a security concern, some data may present a privacy concern, or the like. Performing governance of such models, investigations into suitability of input and output datasets, investigations into validity of conclusions reached by AI, etc., may be an expensive, time consuming, inconvenient, or impractical task. However, as described above, a network operator (e.g., a user) may not have an ability to reliably and quickly obtain, analyze, utilize, or perform corrective actions associated with AI data. In particular, an understanding of what data exactly is provided for training, updating, and as input to an AI model, as well as an understanding of what data output of the model is based on, may be difficult or impossible to ascertain in conventional systems.

In some systems, a thorough understanding and governance of AI may be achieved via a “post-production” process of analyzing data input, data output, correlations of the data, data sources, etc., in order to generate conclusions about efficacy of data usage in the AI environment. As an example, a data study may be performed to investigate data integrity and/or applicability for one or more AI models. The data study, in some systems, will be focused on determining if any aspect of data usage had violated one or more target metrics for a previous period, e.g., the previous 6 months. A subject matter expert (e.g., data scientist, data ethicist, or the like) may spend a considerable amount of time (e.g., several months) performing a manual assessment. The subject matter expert may recover logs, examine the AI environment, examine data sources, determine inherent biases in models or data sets, determine reliability of modeling outcomes from a previous period of time, etc. The subject matter expert may discover a number of problems, biases, correlations, unintended consequences of AI data usage, or the like. The subject matter expert may prepare a report, prepare specific corrective actions, or the like in connection with the investigation. In some systems, soon after completion of a data study (at significant expense, in many cases), a new data study is to be commenced in association with new data consumed and generated in the period of time since the period of concern for the previous study. Such methods may uncover and correct AI data usage that provides different results, questionable ethics, or the like, but these systems are not agile, are far from real time, are a continuous investment, and expensive.

Aspects and embodiments of the present disclosure address the above and other deficiencies by providing a platform of taxonomy and governance for multiple AI applications within a complex environment that may include multiple AI models with different associated bias or ethical considerations. In some embodiments, a classification taxonomy (e.g., stored as metadata) for data may be generated, which then is used to provide continual monitoring and governance of AI applications in a target environment, such as a wireless network. Data usage in the AI environment may be monitored, with taxonomic categorization of data provided to or generated by AI being used by monitoring functions to report to an AI governance function to ensure appropriate data usage by AI models of the AI environment. Such metadata taxonomy further improves transparency of AI decision making, enables use of different overlapping data sets for different applications, etc.

In some embodiments, an AI governance methodology, including multiple models, systems, taxonomies, classifications, etc., may be established. The AI governance system may include generated a taxonomy for data in association with the AI environment. The taxonomy may include any classifications or categorizations of interest for a target application. The AI governance system may apply the taxonomy to one or more data sources of the AI environment. The AI environment may include a data integration pipeline, e.g., for providing input data to one or more AI models, AI agents, autonomous AI models, ML models, decision-making algorithms, etc. The data integration pipeline may be monitored by the AI governance system, e.g., taxonomy of data in the pipeline may be monitored and indications of taxonomies provided to AI applications may be provided to an AI governance function of the AI governance system. The AI environment may further include one or more AI models, AI agents, etc. The AI models, agents, etc., may be monitored by the AI governance system, e.g., via the AI governance function. The AI environment may further include one or more AI output functions or operations, including AI analysis, AI reporting, AI output dashboards, AI monitoring, AI decision making, etc. The AI governance system may further monitor outputs of the AI models, via the governance function.

The AI governance function may monitor whether data in association with AI models is being used in an unintended manner. In some embodiments, a set of rules may be enacted in relation to taxonomy and AI governance. The AI governance function may determine whether data belonging to one or more taxonomic categories has been provided to or generated by an AI model that is incompatible (e.g., in accordance with the set of rules) with that taxonomic category.

Upon obtaining, via monitoring functions, indications that data has been used in association with an AI model in an unintended manner, the AI governance system may enact one or more operations to enforce AI policies. In some embodiments, the AI governance system may provide an alert to a user. For example, behavior of the AI environment may be flagged, provided to a security or AI manager via a dashboard, or the like. In some embodiments, proactive actions may be taken, e.g., monitoring operations may be performed before providing data to an AI model, before using output of an AI model for further decision making, or the like. Monitoring operations resulting in an indication that the data is appropriate for the AI model may be a prerequisite for providing the data to the AI model, for performing actions based on output of the AI model, or the like. Monitoring operations may cause different operations may be performed based on results of the monitoring operations. For example, monitoring operations may determine whether a first operation, such as autonomous AI actions including providing data to another function, device, or system, may be enacted, or a second operation, such as recommending the same action to a user, with an indication of potential misalignments between intended data use and the AI model.

In some embodiments, AI governance may be utilized for ensuring target ethical standards, ensuring AI operations are free of bias, or the like. As an example of ethical bias, an AI algorithm may make decisions and/or recommendations based on a user's zip code. Historical zip code data may include inherent undesired bias, e.g., based on historical redlining, historical biased policies by policy makers, financial institutions or law enforcement, etc. Using an AI model trained on such historical data may encode the historical bias into results of the AI model. Using zip code data as input to an AI model may cause decision making based on biased input data. Utilizing output of an AI model that is generated based on (either through training, input data, or both) such biased data may cause recommendations or actions to be taken that are not in alignment with target decision making reasoning. In some embodiments, a taxonomy system may indicate that some data may present a concern for ethics and bias considerations, e.g., zip code data. Such data may be of use in some applications (e.g., an AI model configured to predict or recommend new locations for network infrastructure) but not other applications (e.g., an AI model configured to recommend whether a loan or payment plan should be extended to a customer). In such a case, a taxonomy classification system may be utilized to govern data usage in AI applications, e.g., by matching taxonomical categories to appropriate AI models, monitoring data ingested and output by AI models, and performing corrective actions (e.g., alerting a user, halting use of some data by or for AI models, etc.) based on the taxonomical categories.

In some embodiments, AI governance may be utilized for optimizing performance of an environment including AI. For example, a wireless network (e.g., a 5G network) may include many physical devices, virtual devices, network components, network functions, etc., which may all interact in complex ways with each other and various user equipment. Network performance, optimization, and operations may be highly integrated with AI models, e.g., autonomous AI models that make decisions and enforce actions for network performance. As examples, security products may include AI based decision making, such as separating traffic that includes confidential information, network slicing to separate certain classes of data, network slicing to provide near-real time response for critical applications (e.g., societal infrastructure, emergency services, autonomous vehicles, etc.), or the like. Including taxonomic data classification may improve visibility into how environment optimization and routing is performed, may be used to confirm that certain biases are not being enacted (e.g., an illegal or undesirable prejudice toward or traffic of one user over another), etc.

In some embodiments, AI governance may be utilized for improving visibility and performance of operations adjacent to network operations, such as data tracking operations of data flowing through the network. For example, analytics regarding target ventures, facilities, or functions may be generated based on network traffic. A facility may include a large number of autonomous devices (e.g., internet of things (IOT) devices, autonomous robots in a manufacturing facility, etc.) which may provide data to the network. The network data may include some information which is appropriate for use in a first AI application (e.g., an application that monitors and recommends updates to policies based on volume of network traffic via identifying data) and some information that is not appropriate for use in an AI application (e.g., data indicative of a device's location or software version may present a security risk if provided to certain models, if data based on that input is provided to an outside device, or the like). AI governance through taxonomy and monitoring may enable these systems to produce results and consume data in accordance with target policies, privacy requirements, and other operational goals.

In some embodiments, a data taxonomy in connection with the current disclosure may be or include a catalog of classifications. The catalog of classifications may be stored as metadata in association with data of the environment (e.g., 5G network). The catalog of classifications may be provided via an in-depth review of data, including data types that are incoming (for example, future data that includes similar features may be automatically characterized with taxonomy recorded in metadata based on one or more models, rules, AI/ML decision making, or the like). Any classifications may be utilized, including but not limited to classifications indicating a level or type of security sensitivity, a level or type of personally identifying information, a level or type of unreliability or inaccuracy, or other categories. In some embodiments, a data taxonomy may include machine-readable and human-readable portions, e.g., a review of data may be available that translates metadata taxonomy markers into human-readable format.

In some embodiments, a modeling system for enforcement may be enacted. The enforcement system may include receiving from a monitoring system indications of data usage in the environment, e.g., 5G network. The monitoring system may report on data usage, data consumption, data generation, models consuming and generating data (e.g., AI models), etc. The enforcement system may be based on one or more models, including enforcement AI models, rule-based models, or the like. For example, a set of rules may be establishing indicating that some data taxonomies are to be used or not to be used in association with some AI models (or categories of AI models, e.g., AI models may also include taxonomy classification). The rules may be interdependent, statistical (e.g., a certain number of violations or frequency of violation may result in a particular action, a different number or frequency result in a different action, etc.), multi-variable (e.g., multiple inputs, such as multiple taxonomy classifications, may be examined by the rule-based system), etc.

Aspects and embodiments of the present disclosure provide improvements over the conventional solutions. By enacting a taxonomic classification-based AI governance system, improved AI outcomes may be achieved. Data visibility may be improved, e.g., a more complete system for tracking and determining which data is being provided to, used by, and output by which AI systems. Data visibility may improve operations related to record-keeping, e.g., in a situation when a manager or governing body requests documentation related to AI usage, taxonomical data may be provided to indicate appropriate use of data, including biased or private data. AI governance may be improved, e.g., data appropriate for target AI applications may be provided to those applications, which may improve accuracy or recommendations or actions taken by autonomous or semi-autonomous AI. Operations enacted by autonomous or semi-autonomous AI may present a security risk, e.g., autonomous AI may enact communication operations which may provide data to unintended recipients. Improved AI governance through data taxonomy enables a network, environment, or user to monitor and/or enforce data delivery based on data taxonomy, e.g., decisions made by AI based on input data including sensitive taxonomies may not be provided outside the environment based on AI governance rules.

In one aspect of the present disclosure, a method includes obtaining an indication that first data including metadata is either provided as input to a first AI model or generated as output from the first AI model. The method further includes determining, based on the metadata, that the first data belongs to a first classification. The method further includes determining, based on an AI taxonomy scheme, that the first AI model is not to be utilized in connection with the first classification. The method further includes performing a corrective action based on the AI taxonomy scheme and the first classification.

It should be noted that 5G and emerging 6G network architectures are based on the concept of virtual network functions and cloud native network functions. Aspects and embodiments of the present disclosure can cause the virtual network functions and/or cloud native network functions to perform self-healing operations in the cellular network and interact with additional embedded artificial intelligence/machine learning (AI/ML) inferences, e.g., for generating predictive data of corrective actions to be performed by the network functions.

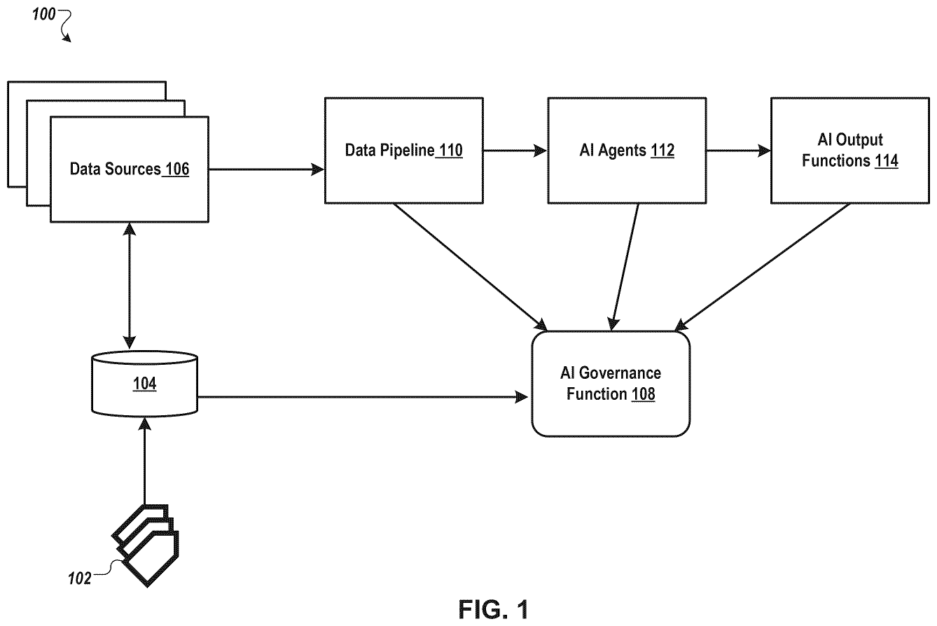

FIG. 1 is a block diagram of an AI governance system 100, including AI governance function 108, according to some embodiments. System 100 includes data store 104 and taxonomy scheme 102. Functions of these components may be performed by or include one or more processing devices, memory banks, network connections, input/output devices, etc. Devices performing functions of system 100 may include one or more general purpose computing device, purpose-built computing devices, customized controllers, desktop computers, personal computers, laptop computers, mobile phones, tablets, programmable processing devices or controllers, single-purpose hardware, or the like. Devices performing functions of system 100 may be cloud-based devices, virtual devices, conceptualized devices, etc. In some embodiments, operations of system 100 may be enacted by one or more network functions of a cellular (e.g., 5G) network, such as a service management and orchestration framework (SMO), non-real time RAN intelligent controller (RIC), or other network function (including a core network function, control plane function, or the like). Data store 104 may include any device for storing and accessing data, including non-transitory machine-readable storage media, optical memory, magnetic memory, flash memory, hard drives, cloud memory, virtual memory, or any other type of data storage that may be applicable to operations of system 100. System 100 may include edge computing devices, e.g., computing devices physically located proximate one or more cellular network components of a cellular network associated with system 100. Self-healing system 100 may include any number of devices, e.g., many server devices executing operations of the various functions including AI governance function 108, many data storage devices including data storage 104, etc. In some embodiments, operations ascribed to one device may be performed by another device, including a virtual machine or cloud-based computing platform. Operations of one or more network functions may be enacted by one or more computing devices.

Various operations of system 100 may be carried out by any network function or network functions of a cellular network. In some embodiments, a service management orchestration framework (SMO) may enact operations of AI governance function 108. An SMO may be responsible for automating, managing, and optimizing network services across different network domains. The SMO may be responsible for network orchestration, e.g., automating deployment, scaling, and lifecycle management of network functions. The SMO may be responsible for radio access network (RAN) optimization and/or automation, e.g., implementing AI/ML driven RAN intelligent controllers (RICs) to optimize radio resource allocation. The SMO may be responsible for performance monitoring, e.g., of key performance indicators. The SMO may be responsible for ensuring seamless integration of network elements from multiple vendors. The SMO may be a good candidate for many of the functions of the present disclosure, as it is often associated with AI operations, network orchestration, network optimization, performance monitoring, etc., which may correspond well to operations of AI monitoring and governance via taxonomy classification.

Network functions of the network may include a network slice selection function (NSSF), e.g., a function responsible for selecting an appropriate network slice for a user, service, group of users, function or facility, or the like. The NSSF may determine an appropriate network slice for a user or request based on user capabilities, current network conditions, etc. The NSSF may ensure that a selected network slice meets required policies and service quality. The NSSF may coordinate with other network functions to facilitate establishment and management of network slices.

Network functions of the cellular network may be or include an authentication server function (AUSF). The AUSF may be responsible for authenticating users, subscribers, user equipment, and the like to ensure accurate and secure access to network services. The AUSF within a cellular network (e.g., a 5G core network) may ensure that legitimate users can access network services. The AUSF may support various authentication methods for different types of user equipment, etc.

Network functions of the network associated with system 100 may be or include unified data management (UDM). The UDM may be responsible for managing subscription data. The UDM may store and manage subscription data, user profiles, subscription information, etc. The UDM may support authentication and authorization processes by providing subscriber data to other network functions, such as the AUSF. The UDM may interact with a policy control function (PCF) to apply policies based on subscriber status. The UDM may support mobility management by providing data to an access and mobility management function (AMF) or other network functions.

Network functions of the network may be or include a network exposure function (NEF). A network exposure function may be responsible for exposing network capabilities and services to external applications and services, e.g., through well-defined application programming interfaces (APIs) or other applicable communication interfaces. The NEF may perform data filtering and transformation to improve data quality and ensure authorized data is exposed to external applications. The NEF may orchestrate interactions between network functions and external applications.

Network functions of the network may be or include a network repository function (NRF). In some embodiments, data generated by AI governance function 108 may be provided to an NRF, e.g., when network function is a network function different than the NRF. The NRF allows different network functions to register their services and capabilities. This may include providing information about the services offered by the network functions and the interfaces (e.g., communication interfaces) the network functions support. The NRF may enable various network functions to discover and communicate with each other. The NRF may responds to requests from various network functions requesting services or functionality, providing details of network functions that may provide the requested services. The NRF may maintain and provide status information about network functions, including availability and load. The NRF may be used to facilitate monitoring of various data streams in connection with AI models in the network, e.g., the NRF may coordinate monitoring of data pipeline 110, AI agents 112, AI output functions 114, etc.

Network functions of the network may be or include an access and mobility management function (AMF). The AMF manages tasks related to access and mobility of user equipment. The AMF may handle registration of user equipment. The AMF may manage establishment, maintenance, and release of connections for user equipment via the cellular network, including handovers as user equipment moves between geographical regions served by different radio units. The AMF may be involved in and/or support authenticating user equipment to ensure secure access to the network, e.g., in cooperation with the AUSF. The AMF may perform functions to locate and connect user equipment to the network when required, e.g., when a phone receives a call. The AMF may interact with radio units to manage and control radio resources.

Network functions of the network may be or include a session management function (SMF). The SMF may manage functions related to sessions of user equipment connectivity to the cellular network. The SMF may establish, modify, and release session. The SMF may allocate IP addresses and manage session states. The SMF may enforce policies related to service quality and traffic routing. The SMF may coordinate with the policy control function to apply network policies based on subscription information and network conditions. The SMF may interface with the user plane function to manage data forwarding and routing, and ensure data packets are properly routed and delivered via the cellular network. The SMF may support creation and management of network slices.

Network functions of the network may be or include a policy control function (PCF). The policy control function may manage policy decisions and enforce policies. The PCF may enforce policies related to network resource usage, quality of service, subscription access, etc. The PCF may interact with other network functions to provide policy decisions that guide the handling of sessions, mobility events, and other network activities.

Taxonomy scheme 102 includes any classifications of use in the AI environment (e.g., 5G network). The taxonomy scheme 102 may be provided by one or more users, subject matter experts, risk management experts, data ethicists, or the like. Taxonomy scheme 102 may include any number of classifications, which may be related to any AI-based network function of interest. In some embodiments, taxonomy scheme 102 may be manually applied to data included in data store 104, e.g., data that may be used as input to AI models, data that may be used to train, update, or retrain AI models, etc. Taxonomy classification may be stored, for example, as metadata associated with the data catalog of data store 104. In some embodiments, taxonomy scheme 102 may be applied to data included in data store 104 based on one or more rules, e.g., established by users. In some embodiments, taxonomy scheme 102 may be applied to data included in data store 104 based on one or more models, e.g., AI models, statistical models, or the like. Such autonomous taxonomy assignment may include or be associated with human-in-the-loop processing, e.g., may be dependent upon approval upon review by a subject matter expert.

In some embodiments, data store 104 may be configured to automatically add (e.g., via a data gathering function) data from data sources 106 to data store 104. In some embodiments, data added from data sources 106 to data store 104 may be automatically categorized according to taxonomy scheme 102, may be flagged or placed in a queue awaiting classification by a subject matter expert, or the like. Data sources 106 may include sensor data, probe data, customer or user data, vendor data, device data, data packets, meta data of data packets, contextual data (e.g., date, time, location, etc.), or any other data source of relevance to the AI functions of the environment (e.g., 5G network).

Data sources 106, upon receiving classification, being updated to reflect classification data (e.g., as metadata), etc., may be provided to data pipeline 110. The data pipeline 110 may include one or more pathways for data to be provided to various AI models, e.g., as input data or as training data. Data pipeline 110 may be monitored by (e.g., information regarding taxonomy of data in data pipeline 110 may be transmitted to) AI governance function 108, which may be executed as part of an extant network function, such as the SMO. Monitoring of data pipeline 110 may include being provided information regarding data being passed between various network functions, between components of the network, being prepared to be provided to an AI agent (e.g., preprocessing or formatting operations in relation to preparing data to be input to an AI model may be monitored), data being passed out of the environment (e.g., for potential use in an external AI model), or the like. AI governance function 108, upon receiving an indication that data of data pipeline 110 may be used in a way that is not in accordance with target data applications, may perform a corrective action, such as providing an alert to a user, enforcing a rule to stop data usage in association with an AI model or external connection, or the like.

AI agents 112 may receive data from data pipeline 110, and may also be monitored by AI governance function 108. AI agents 112 may be applications, functions, modules, or the like which are configured to provide input data to AI models and/or obtain output from the AI models. The AI agents 112 may provide taxonomy classification data from input data and/or output data to AI governance function 108, which may enforce one or more corrective actions with respect to data usage in the AI environment (e.g., network). Any mismatch between taxonomy and an AI model may cause AI governance function 108 to perform one or more corrective actions. AI agents 112 (or another function) may further be configured to label output of AI models with taxonomy classification data, e.g., based on taxonomy of the input data used to generate the output data, based on taxonomy of the training data used to generate the AI model, etc.

AI output functions 114 may include any use of the data generated by the AI models, and may be provided as output from AI agents 112. AI output functions 114 may further be monitored by AI governance function 108. AI output functions may include analysis, reporting, dashboard alerts, etc. AI output functions may include AI monitoring. AI output functions may include AI-based decision making, including adjustments to network operations, transmitting of data to external systems, or the like. AI governance function 108 may enact one or more corrective actions based on monitoring of AI output functions 114.

In some embodiments, further monitoring systems may be enacted. For example, a vendor may allow a network access to their internal network, e.g., in an enterprise application where increased data transparency or leveraging of network operator expertise is targeted. In such cases, external functions may also report to AI governance function 108 based on data taxonomy classifications and usage by AI models of the external system.

Operations of system 100 may be utilized in cellular networks, 5G networks, emerging 6G networks, or other types of networks including various network functions that may benefit from AI governance operations. Any communication models in accordance with third generation partnership project (3GPPP) standards for mobile networks may utilize aspects of the present disclosure for AI governance functions. Cellular network operations performed in cloud environments, core network functionality, edge computing devices, or the like may each incorporate AI governance components. An AI governance component may be utilized on public, private, or hybrid network environments, including cloud network environments.

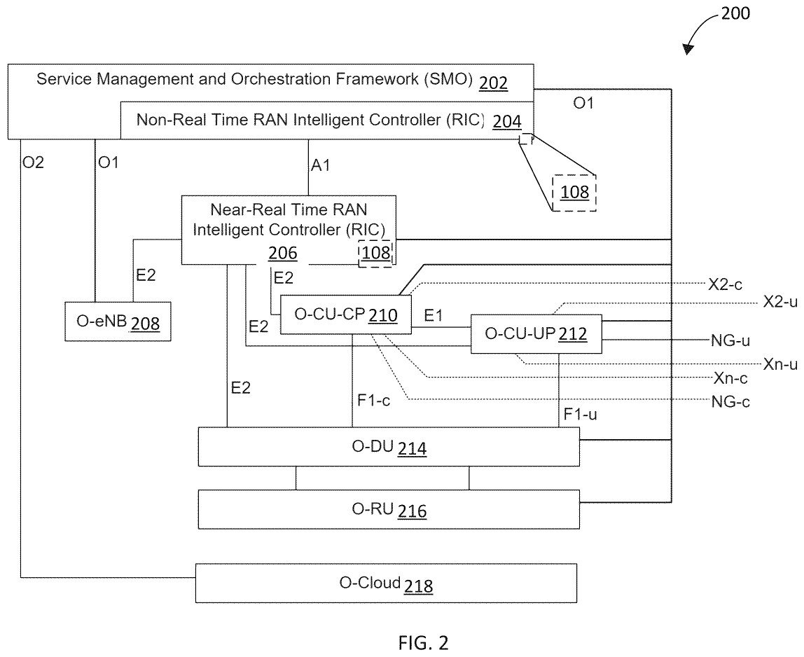

FIG. 2 shows an illustrative system 200 corresponding to an Open Radio Access Network (O-RAN) architecture with AI governance function 108 according to at least one embodiment. In this example, the Open Radio Access Network software community (O-RAN SC) architecture follows the O-RAN alliance defined architecture. The O-RAN standard introduced a radio access network intelligent controller (RIC) and broke out the functionality of the RIC into non-real time actions that processed any delay tolerant actions and near-real time actions that covered any immediate actions. In particular, the non-real time actions are performed by a non-real-time RIC 204 and the near-real time actions are performed by a near-real-time RIC 206.

A RIC is a component within a cellular network architecture, designed to bring intelligence and flexibility to the RAN. The RIC enables more efficient use of network resources, improves network performance, and facilitates the deployment of new services through the orchestration and automation of network functions. The RIC can utilize real-time data analytics and machine learning/AI algorithms to dynamically optimize the RAN. This includes adjusting network parameters for optimal performance, managing interference, and optimizing handovers between cells, thereby enhancing the overall user experience. The RIC can enable policy-driven control of RAN resources, allowing operators to implement network policies that align with business objectives, such as prioritizing certain types of traffic, users, or services to ensure quality of service (QoS) and quality of experience (QoE). The RIC can also manage network slices, which are logically isolated network partitions tailored for specific services or customer needs. The RIC can help in creating, modifying, and terminating slices, ensuring that each slice meets its specific performance, latency, and reliability requirements. As described above, a RIC can be the Near-Real-Time RIC 206 or the Non-Real-Time RIC 204. The Near-Real-Time RIC 206 can operate on a timescale of tens of milliseconds to one second. It is tailored for use cases requiring rapid response times, such as dynamic radio resource management and interference mitigation. The Non-Real-Time RIC 204 can operate on a timescale of one second or longer. The Non-Real-Time RIC 204 can focus on longer-term RAN optimization and policy management, including predictive analysis and planning based on historical data. Either one of the Non-Real-Time RIC 204, the Near-Real-Time RIC 206, or both may be involved in operations of AI governance, including hosting one or more AI agents, hosting one or more AI models, providing taxonomy classification monitoring, enforcement, and governance operations, etc.

The system 200 may include a service management and orchestration framework SMO 202, which may interface with other components of the system 200, such as, an Open Cloud Open Cloud (O-Cloud) 218 and the near-real-time RIC 206. SMO 202 may further include the non-real-time RIC 204. In some implementations, near-real-time RIC 206 may further communicate with an evolved NodeB (O-eNB) 208, which in some implementations corresponds to the hardware aspect of a 4G radio access network. Near-real-time RIC 206 also further interfaces with centralized units (CU), including an open centralized unit-control plane node (O-CU-CP) 210 and an open centralized unit-user plane node (O-CU-UP) 212, as well as an open distributed unit (O-DU) 214, and an open radio unit (O-RU) 216, as further shown in FIG. 2. Since the non-real-time RIC 204 handles the delayed tolerant applications, the non-real-time RIC 204 can communicate using the O1 interface. As shown in FIG. 2, the O1 interface is not delay sensitive, whereas the near-real-time RIC 206 is configured to control time sensitive applications and uses the E2 network interface for time-sensitive applications.

In the context of FIG. 2, radio access network (e.g., gNB, gNodeB, or base station) disaggregation corresponds to an initial phase of the deployment of Fifth Generation (5G) technology, and a major application will be Enhanced Mobile Broadband (eMMB). Radio access network disaggregation can be performed according to the 3rd Generation Partnership Project (3GPP) or according to the O-RAN specification illustrated in the illustrative example of FIG. 2.

In at least one embodiment, the non-real-time RIC 204 and/or near-real-time RIC 206 can cause an RU to be turned off for a period of time in the time (T) domain. While the RU is turned off for a period of time, the non-real-time RIC 204 and/or near-real-time RIC 206 can compensate coverage by making beam adjustments of neighboring cells' mMIMO RU to cover the target cells' direction or coverage area. While the RU is turned off for a period of time, the non-real-time RIC 204 and/or near-real-time RIC 206 can cause utilization of smaller cells in heterogenous RAN environments. While the RU is turned off for a period of time, the non-real-time RIC 204 and/or near-real-time RIC 206 can adjust the coverage enhancement features of neighboring cells' DU/RU.

In at least one embodiment, the non-real-time RIC 204 and/or near-real-time RIC 206 can cause an RU to turn off a set of carriers or bands in the frequency (F) domain. For example, the non-real-time RIC 204 and/or near-real-time RIC 206 can preferentially turn off carrier/bands with higher frequencies or lower Effective Isotropic Radiated Power (EIRP) since they have less impact on coverage. While the set of carrier/band is turned off for a period of time, the non-real-time RIC 204 and/or near-real-time RIC 206 can adjust the coverage enhancement features for the target cell's remaining carriers/bands.

In at least one embodiment, the non-real-time RIC 204 and/or near-real-time RIC 206 can cause an RU to turn off a set of mMIMO antennas in the space(S) domain. For example, the non-real-time RIC 204 and/or near-real-time RIC 206 can adjust the antenna for vertical beams (e.g., in a rural area), horizontal beams (e.g., in a building area within indoor coverage) based on the UE distribution and morphology. The non-real-time RIC 204 and/or near-real-time RIC 206 can adjust the beam weight so that the number of working beams is reduced and the beam gain is increased. The non-real-time RIC 204 and/or near-real-time RIC 206 can adjust the coverage enhancement features of the target RU's and/or the neighboring cell's DU/RU.

In at least one embodiment, the non-real-time RIC 204 and/or near-real-time RIC 206 can use the following coverage control parameters, such as downlink (DL) and uplink (UL) coverage enhancement configurations, to achieve energy savings in the network while maintaining network performance. In at least one embodiment, the DL coverage enhancements can include adjustments to enable and/or modify the configurations of DL coverage related features, such as DL Cooperative Multi-Point (DL CoMP) transmission, Multiple Transmission Reception Point (mTRP) transmission, Resource Element (RE) power boosting, or the like.

DL CoMP transmission is a communication technique used in cellular networks to improve signal quality and increase throughput, especially at cell edges where users may experience poor signal strength due to interference from neighboring cells. This technology involves the coordination of signal transmission from multiple base stations or cell sites to a single user equipment (UE) in a synchronized manner, effectively increasing the signal strength and reducing the impact of interference. The main principle behind DL CoMP is to turn what would traditionally be interfering signals from neighboring cells into useful signals that can enhance the overall signal quality received by a UE. This is achieved through precise timing, phase adjustment, and power control of the signals transmitted from different cells. In some embodiments, one or more operations related to DL CoMP may be recommended, initiated, enacted, or the like by AI models of the network. The AI governance function 108 can be used to monitor, govern, enforce restrictions, etc., in accordance with subject matter expert guidance, of one or more AI models used for network performance in the network.

Multiple Transmission Reception Point (mTRP) transmission is a technology for enhancing signal reliability, network capacity, and user experience through the use of multiple transmitters and receivers distributed across different geographical locations. By leveraging signals from multiple transmission and reception points, mTRP can significantly improve the signal-to-noise ratio (SNR) at the user equipment (UE). This results in better signal quality, faster data rates, and lower bit error rates. By utilizing multiple points for transmission and reception, mTRP can extend the reach of the network to areas that might be challenging to cover through traditional single-point transmission, such as indoor environments or densely populated urban areas with numerous obstructions. These and other functions of a network may be enacted or effected by operations of one or more AI models, operating in various network functions within the cellular network. IN some embodiments, AI governance function 108 (which may be located in Non-Real Time RIC 204, SMO 202, Near-Real Time RIC 206, or another network function) may be used to monitor operations of the AI models, enforce compliance with target regulations of the AI models and associated data, etc.

In some embodiments, the AI governance function 108 can be implemented in one or more RIC applications controlled via a RIC platform in the context of a telecommunications network where the RIC is able to communicate with the platform extension and adapters to provide network functions for different vendors services. Historically, a RAN intelligent controller (RIC) was a software-defined component of the Open Radio Access Network (O-RAN) that was responsible for controlling and optimizing RAN functions. The O-RAN set a standard for virtual RAN run on standard servers. Historically, the RIC was able to service commercial vendors using the network resources available on the RIC, however, the RIC was unable to efficiently use resources in a way that allowed for multiple vendors to use redundant resources efficiently. In one example, the RIC platform is a non-real time RIC and the network function includes the AI governance function 108. In one example, the RIC platform is a near-real time RIC and the network function is a time-sensitive network function. In at least one embodiment, a first dedicated network controller implements a first portion of the AI governance function 108 and a second dedicated network controller implements a second portion of the AI governance function 108.

In at least one embodiment, long-term decisions can be made by the non-real-time RIC 204. Based on statistical data collection for the number of active UEs and the traffic per time/carrier/band/beam, the non-real-time RIC 204 can decide when (T: hour-level), what carrier/band (F), what antenna/beam(S), etc. The non-real-time RIC 204 can perform one or more actions, including applying the mode in the time decided (T: hour-level) for the part of carrier/band's antenna/beam (F×S). The non-real-time RIC 204 can also perform additional operations for compensation. The non-real-time RIC 204 can perform coverage replacement through rebalancing the carrier/band(F) of small UE/traffic to neighboring carrier/band(F) or adjusting the beam(S) of neighboring cells. Operations of the non-real-time RIC 204 may be enacted or informed by AI models which have data usage monitored and/or enforced by AI governance function 108.

In at least one embodiment, mid-term decisions can be made by the near-real-time RIC 206. The near-real-time RIC 206 can apply which slot (T) and which antenna/beam(S) to be in use, and/or make other decisions for network optimization, tracking of data flowing through the network, etc. The near-real-time RIC 206 can perform one or more actions, based on recommendations or output of one or more AI models. The one or more AI models may be constrained in their data usage to only data relevant or intended for those models by AI governance function 108.

This application also further discloses a non-transitory computer-readable medium encoded with instructions that, when executed by a physical processor of a computing device, cause the computing device to perform the method of one or more embodiments of the method outlined above. This application also further discloses a system configured to perform one or more of the embodiments outlined above.

In some implementations, a system (e.g., system 100 in FIG. 1, or system 200 in FIG. 2) may include a computing system to facilitate a cellular network. The computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 11, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to the functionality described herein.

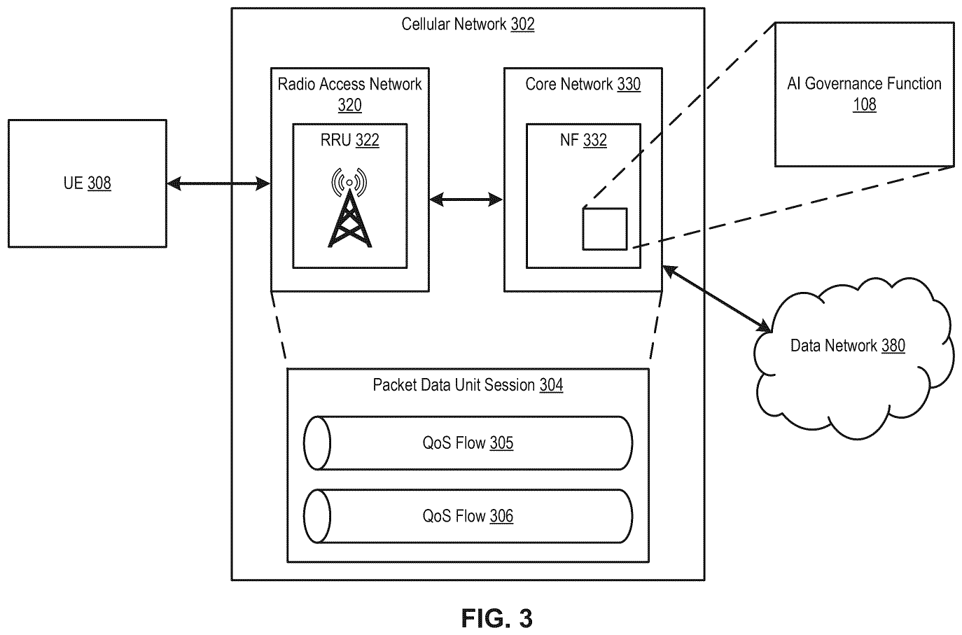

FIG. 3 depicts a cellular network 302 (e.g., a 5G network) including a radio access network (RAN) 320 and a core network 330 configured to utilize taxonomy classification of data for AI governance, according to some embodiments. In at least one embodiment, the AI governance function 108 of FIG. 1 can be implemented in network 302 to provide self-healing capabilities as described herein. The AI governance function 108 may be executed as part of core network 330. The RAN 320 can include a new-generation radio access network (NG-RAN) that uses the 5G new radio interface (NR). The cellular network 302 connects user equipment (UE) 308 to the data network (DN) 380 using the RAN 320 and the core network 330. The data network 380 can include the Internet, a local area network (LAN), a wide area network (WAN), a private data network, a wireless network, a wired network, or a combination of networks. The UE 308 can include an electronic device with wireless connectivity or cellular communication capability, such as a mobile phone or handheld computing device. In at least one example, the UE 308 can include a 5G smartphone or a 5G cellular device that connects to the RAN 320 via a wireless connection. The UE 308 can include one of a number of UEs not depicted that are in communication with the RAN 320. The UEs may include mobile and non-mobile computing devices. The UEs may include laptop computers, desktop computers, an Internet-of-Things (IoT) devices, and/or any other electronic computing device that includes a wireless communications interface to access the RAN 320.

The RAN 320 includes a remote radio unit (RRU) 322 for wirelessly communicating with UE 308. The remote radio unit (RRU) 322 can include a Radio Unit (RU) and may include one or more radio transceivers for wirelessly communicating with UE 308. The remote radio unit (RRU) 322 may include circuitry for converting signals sent to and from an antenna of a Base Station into digital signals for transmission over packet networks. The RAN 320 may correspond with a 5G radio Base Station that connects user equipment to the core network 330. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 308.

The core network 330 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols, SIP protocols, diameter protocols, and/or APIs. In at least one embodiment, the AI governance function 108 can be implemented in control plane (CP) functions executed by core network 330. In at least one embodiment, an architecture in which software is composed of small independent services that communicate over well-defined APIs may be used for implementing some of the core network functions. For example, control plane (CP) network functions for performing session management may be implemented as containerized applications. A container-based implementation may offer improved scalability and availability over other approaches.

The primary core network functions can include the access and mobility management function (AMF), the session management function (SMF), and the user plane function (UPF), SMO, or other functions represented by network function 332. The UPF (e.g., represented as network function 332) may perform packet processing including routing and forwarding, quality of service (QoS) handling, and packet data unit (PDU) session management. The UPF may serve as an ingress and egress point for user plane traffic and provide anchored mobility support for user equipment. For example, the UPF may provide an anchor point between the UE 308 and the data network 380 as the UE 308 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 320, such as a Distributed Unit (DU) and a centralized unit (CU), may need to be deployed at a cell site or in a local data center (LDC) that is in close proximity to a cell site such that the latency requirements are satisfied (e.g., such that the one-way latency from the cell site to the DU component or CU component is less than 1.2 ms).

In some embodiments, the Distributed Unit (DU) and the centralized unit (CU) of the RAN 320 may be co-located with the remote radio unit (RRU) 322. In other embodiments, the Distributed Unit (DU) and the remote radio unit (RRU) 322 may be co-located at a cell site and the centralized unit (CU) may be located within a local data center (LDC).

The cellular network 302 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the cellular network 302. In some cases, the cellular network 302 may support customized policy configuration and enforcement between network slices per service level agreements (SLAs) within the radio access network (RAN) 320. User equipment, such as UE 308, may connect to multiple network slices at the same time (e.g., eight different network slices). In one embodiment, a PDU session, such as PDU session 304, may belong to only one network slice instance.

In some cases, the cellular network 302 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents. Operations of AI governance function 108 may be executed based on cloud computing resources.

The core network 330 may include a set of network elements that are configured to offer various data and telecommunications services to subscribers or end users of user equipment, such as UE 308. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The cellular network 302 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 3, the core network 330 includes a network function 332 (e.g., a UPF) for transporting IP data traffic (e.g., user plane traffic) between the UE 308 and the data network 380 and for handling packet data unit (PDU) sessions with the data network 380. The UPF can include an anchor point between the UE 308 and the data network 380. The UPF may be implemented as a software process or application running within a virtualized infrastructure or a cloud-based compute and storage infrastructure. The cellular network 302 may connect the UE 308 to the data network 380 using a PDU session 304, which can include part of an overlay network.

The PDU session 304 may utilize one or more quality of service (QoS) flows, such as QoS flows 305 and 306, to exchange traffic (e.g., data and voice traffic) between the UE 308 and the data network 380. The one or more QoS flows can include the finest granularity of QoS differentiation within the PDU session 304. The PDU session 304 may belong to a network slice instance through the cellular network 302. To establish user plane connectivity from the UE 308 to the data network 380, an AMF that supports the network slice instance may be selected and a PDU session via the network slice instance may be established. In some cases, the PDU session 304 may be of type IPv4 or IPv6 for transporting IP packets. The RAN 320 may be configured to establish and release parts of the PDU session 304 that cross the radio interface.

The RAN 320 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 308, over a geographic area. Some cells may correspond with stationary coverage areas and other cells may correspond with coverage areas that change over time (e.g., due to movement of a mobile RRU).

In some cases, the UE 308 may be capable of transmitting signals to and receiving signals from one or more RRUs within the network of cells over time. One or more cells may correspond with a cell site. The cells within the network of cells may be configured to facilitate communication between UE 308 and other UEs and/or between UE 308 and a data network, such as data network 380. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

A UPF represented as network function 332 may be responsible for routing and forwarding user plane packets between the RAN 320 and the data network 380. Uplink packets arriving from the RAN 320 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 320 and the UPF.

The UPF may remove the packet headers belonging to the GTP tunnel before forwarding the user plane packets towards the data network 380. As the UPF may provide connectivity towards other data networks in addition to the data network 380, the UPF must ensure that the user plane packets are forwarded towards the correct data network. Each GTP tunnel may belong to a specific PDU session, such as PDU session 304. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network 380 are mapped onto a specific QoS flow belonging to a specific PDU session before forwarded towards the appropriate RAN 320. A QoS flow may correspond with a stream of data packets that have equal quality of service (QoS). A PDU session may have multiple QoS flows, such as the QoS flows 305 and 306 that belong to PDU session 304. The UPF may use a set of service data flow (SDF) templates to map each downlink packet onto a specific QoS flow. The UPF may receive the set of SDF templates from a session management function (SMF) during setup of the PDU session 304. The SMF may generate the set of SDF templates using information provided from a policy control function (PCF). The UPF may track various statistics regarding the volume of data transferred by each PDU session, such as PDU session 304, and provide the information to an SMF.

Many of the functions of the various network components, including physical components (e.g., RRU 322), network function, computing devices, aggregators and signal processors (e.g., DUs and CUs), may be facilitated, enhanced, and/or performed by AI models.

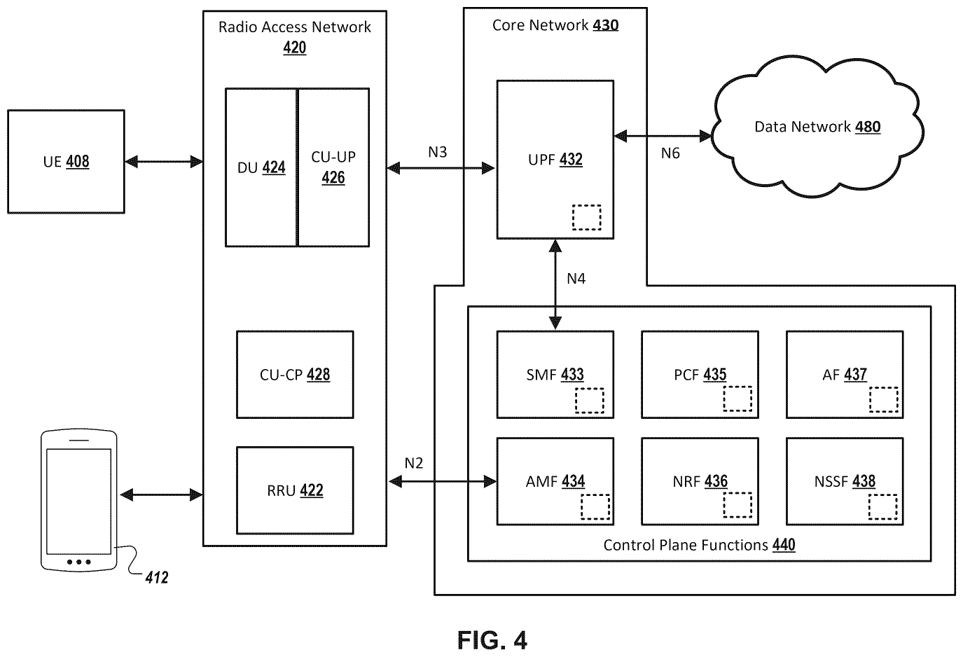

FIG. 4 depicts a RAN 420 and a core network 430 for providing a communications channel (or channel) between user equipment and data network 480, including an AI governance component, according to at least one embodiment. In at least one embodiment, the AI governance function 108 may be implemented in one or more network functions of the core network 430, represented by dashed boxes in various network functions, as described herein. The communications channel can include a pathway through which data is communicated between the UE 408 and the data network 480. The user equipment in communication with the RAN 420 includes UE 408, and mobile computing device 412. The user equipment may include a set of electronic devices, including mobile computing device and non-mobile computing device.

The core network 430 includes network functions (e.g., including in control plane functions 440) such as an access and mobility management function (AMF) 434, a session management function (SMF) 433, and a user plane function (UPF) 432. The core network 430 further includes policy control function (PCF) 435, network repository function (NRF) 436, application function (AF) 437, and network slice selection function (NSSF) 438. Other network functions including the SMO may also be applicable to aspects of the present disclosure. The AMF may interface with user equipment and act as a single-entry point for a UE connection. The AMF may interface with the SMF to track user sessions. The AMF may interface with a network slice selection function (NSSF 438) to select network slice instances for user equipment, such as UE 408. When user equipment is leaving a first coverage area and entering a second coverage area, the AMF may be responsible for coordinating the handoff between the coverage areas whether the coverage areas are associated with the same radio access network or different radio access networks.

The control plane functions 440 may further interface with network function-related data functions, including the unified data repository (UDR) and unified data management (UDM). The UDR may act as a centralized data storage system in the core network 430. The UDR may store various data that can be accessed by network functions of the network. The UDR may store application data, policy data, contextual and session data, or other types of data. Various data types related to data taxonomy may be stored by the UDR. The UDM may interface with the UDR to retrieve and/or update data. The UDM may manage subscribers, authentication, authorization, and/or mobility management in a cellular network.

In some embodiments, the SMF 433 may query the NRF 436 to identify a set of available UPFs for a packet data unit (PDU) session and acquire UPF information from a variety of sources, such as the AMF 434 or the UE 408. The UPF information may include a location of the UPF 432, a location of the UE 408, and/or mobile computing device 412, etc., the UPF's dynamic load, the UPF's static capacity among UPFs supporting the same data network, and the capability of the UPF 432.

The UPF 432 may transfer downlink data received from the data network 480 to user equipment, such as UE 408, via the RAN 420 and/or transfer uplink data received from user equipment to the data network 480 via the RAN 420. An uplink can include a radio link though which user equipment transmits data and/or control signals to the RAN 420. A downlink can include a radio link through which the RAN 420 transmits data and/or control signals to the user equipment.

The RAN 720 may be logically divided into a remote radio unit (RRU) 422, a Distributed Unit (DU) 424, and a centralized unit (CU) that is partitioned into a CU user plane portion (CU-UP) 426 and a CU control plane portion (CU-CP) 428. The CU-UP 426 may correspond with the centralized unit for the user plane and the CU-CP 428 may correspond with the centralized unit for the control plane. The CU-CP 428 may perform functions related to a control plane, such as connection setup, mobility, and security. The CU-UP 426 may perform functions related to a user plane, such as user data transmission and reception functions.

Decoupling control signaling in the control plane from user plane traffic in the user plane may allow the UPF 432 to be positioned in close proximity to the edge of a network compared with the AMF 434. As a closer geographic or topographic proximity may reduce the electrical distance, this means that the electrical distance from the UPF 432 to the UE 408 may be less than the electrical distance of the AMF 434 to the UE 408. The RAN 420 may be connected to the AMF 434, which may allocate temporary unique identifiers, determine tracking areas, and select appropriate policy control functions (PCFs) for user equipment, via an N2 interface. The N3 Interface may be used for transferring user data (e.g., user plane traffic) from the RAN 420 to the user plane function UPF 432 and may be used for providing low-latency services using edge computing resources. The electrical distance from the UPF 432 (e.g., located at the edge of a network) to user equipment, such as UE 408, may impact the latency and performance services provided to the user equipment.

The UE 408 may be connected to the SMF 433 via an N1 interface not depicted, which may transfer UE information directly to the AMF 434. The UPF 432 may be connected to the data network 480 via an N6 interface. The N6 interface may be used for providing connectivity between the UPF 432 and other external or internal data networks (e.g., to the Internet). The RAN 420 may be connected to the SMF 433, which may manage UE context and network handovers between Base Stations, via the N2 interface. The N2 interface may be used for transferring control plane signaling between the RAN 420 and the AMF 434.

The RRU 422 may perform physical layer functions, such as employing orthogonal frequency-division multiplexing (OFDM) for downlink data transmission. In some cases, the DU 424 may be located at a cell site (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different cell sites (or cellular Base Stations) and 180 different RRUs.

In some embodiments, the RAN 420 or portions of the RAN 420 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 424 and CU-UP 426 may be executed as virtual instances within a data center environment that provides single-digit millisecond latencies (e.g., less than 2 ms) from the virtual instances to the UE 408.

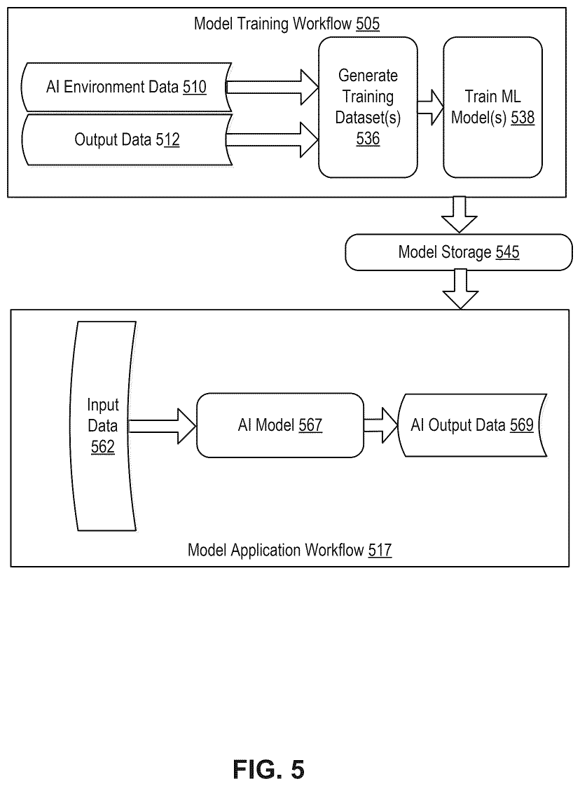

FIG. 5 illustrates a model training workflow 505 and a model application workflow 517 for cellular network data in connection with self-healing network function operations, in accordance with some embodiments of the present disclosure. In embodiments, the model training workflow 505 may be performed at a server or processing device which may or may not be included in architecture of a cellular network (e.g., a computing device of a 5G network executing a software defined data pipeline control module), and the trained models are provided to an edge computing device proximate one or more components of the network, which may perform the model application workflow 517. In some embodiments, one or more network functions may execute one or more of model training workflow 505 or model application workflow 517. The model training workflow 505 and the model application workflow 517 may be performed by processing logic executed by a processor of a computing device. One or more of these workflows 505, 517 may be implemented, for example, by one or more machine learning modules implemented by components of system 100 of FIG. 1, e.g., AI agents 112.

Various functions of AI models may be trained via model training workflow 505, implement via model application workflow 517, etc. For example, decision making data related to personal information (e.g., loan applications), decision making data related to environment operations (e.g., cellular network probe data for adjusting operations of the network), decision making data related to monitoring, optimizing, adjusting, diagnosing, or the like one or more devices associated with data flowing through the AI environment, or the like. AI models associated with model training workflow 505 and/or model application workflow 517 may be monitored, adjusted, and/or governed by an AI governance function in accordance with embodiments of this disclosure. AI models associated with model training workflow 505 and/or model application workflow 517 may be included in or used by AI governance functions in accordance with this disclosure. For example, autonomous AI may classify input, training, or output data in accordance with an AI governance taxonomy.

In one embodiment, the trained machine learning model is a decision tree, a random forest model, a support vector machine, or other type of machine learning model.

In one embodiment, the trained machine learning model is an artificial neural network (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

In some embodiments, a model (e.g., a model configured to adjust operations of a cellular network, a model configured to make decisions about customers of a cellular network, or the like) may be implemented as a rule-based model, with capability to be adjusted or updated subject to feedback on operations of the model. The trained machine learning model may be periodically or continuously retrained to achieve continuous learning and improvement of the trained machine learning model. The model may generate an output based on an input, an action may be performed based on the output, and a result of the action may be measured. In some instances, the result of the action is measured within seconds or minutes, and, in some instances, it takes longer to measure the result of the action. For example, one or more additional processes may be performed before a result of the action can be measured. The action and the result of the action may indicate whether the output was a correct output and/or a difference between what the output should have been and what the output was. Accordingly, the action and the result of the action may be used to determine a target output that can be used as a label for the measurements. Once the result of the action is determined, the input (e.g., error data), the output of the trained machine learning model (e.g., recommended corrective actions), and the target result (e.g., correction of a condition of the cellular network not satisfying a target threshold) actual measured result (e.g., measured condition of the network) may be used to generate a new training data item. The new training data item may then be used to further train the trained machine learning model. This retraining process may be performed by components of a software defined cellular network in embodiments.

The model training workflow 505 is to train one or more machine learning models (e.g., deep learning models) to perform one or more classifying, segmenting, detection, recognition, decision, etc., tasks associated with a cellular network. The model application workflow 517 is to apply the one or more trained machine learning models to perform the classifying, segmenting, detection, recognition, determining, etc. tasks for generating predictive data in association with the cellular network, such as recommended corrective actions, data to generate insights or key performance indicators, etc.

Various machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
a. Generation of recommended actions with respect to customers or vendors—In some embodiments, one or more AI models may be used to predict actions to be taken with respect to a user, customer, vendor, or the like. Such AI models may be sensitive to inherent bias included in training or input data, and protection from such bias may be achieved via an AI governance system.
b. Enacting corrective actions for adjusting performance—In some embodiments, one or more AI models may exist within an environment and exert some control of operations of that environment. For example, AI models may operate with a cellular network (e.g., within various network functions of a 5G network) and may perform operations to optimize, improve, adjust, or the like network performance. Corrective actions in relation to updating or adjusting network function may include rerouting network data traffic, deregistering one or more network functions, bypassing one or more network functions, bypassing one or more pieces of network equipment, adjusting network slicing, adjusting radio signals including power output, beam shaping, or directionality, adjusting radio resource allocation, adjusting processing or computing device resource allocation, providing connectivity data to a central control function, or other operations to adjust performance of the network. Such AI models may benefit form taxonomy classification of data and related AI governance, e.g., to indicate that some data is not to be used for some decision-making processes, such as unusual data circumstances (e.g., data provided additional speed or computing power, such as data related to emergency services) being used as input to affect normal operations of the network. Further, data taxonomy may improve accountability, visibility, and reporting, e.g., by demonstrating that unintended decision making (such as prioritizing one type or source of data over another) has not been systemically recommended by AI models based on taxonomy of the associated data.
c. Tracking and modeling data flow—In some embodiments, AI governance may be utilized in connection with AI models that monitor data of the AI environment (e.g., cellular network) for performing or recommending actions outside the operations of the AI environment. For example, monitoring data sources, input devices, user equipment, location data, etc., may provide valuable insight for improving network infrastructure, improving user or customer experience, improving interfaces between various nodes of the network, etc. Some data may be of use to such AI models, and some may not be appropriate, such as data that may present a privacy or security concern, data that has been specifically determined to be private, or the like. AI governance systems based on taxonomy classification may enable enforcement of such regulations on the AI system, the cellular network, etc.
d. Classificaion of data—In some embodiments, improved AI governance include or be based on classification of data, e.g., recorded in metadata. The data may be AI training data, AI input data, AI output data, or the like. In some cases, data may be automatically classified (e.g., have tags indicative of relevant taxonomy applied to the data) by one or more AI models.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

For the model training workflow 505, a training dataset containing hundreds, thousands, tens of thousands, hundreds of thousands or more AI environment data 510 (e.g., combinations of error codes or status codes, contextual data, error frequency data, etc.) should be used to form a training dataset. AI environment data 510, in this context, includes any data that may be used in the AI-controlled, AI-influenced, or AI-analyzed environment (e.g., a cellular or 5G network) by one or more AI models. AI environment data 510 may include data provided for consumption or training of AI models, as well as metadata and/or categorization data related to data taxonomy for additional control and governance of the AI models in the AI-influenced environment. In some embodiments, the training dataset may also include associated outcome data 512 (e.g., associated key performance indicator values, associated corrective actions, associated data to transfer to a central module or another network function, etc.) for forming a training dataset, where each data point and/or associated configuration may include various labels or classifications of one or more types of useful information. This data may be processed to generate one or multiple training datasets 536 for training of one or more machine learning models.

To effectuate training, processing logic inputs the training dataset(s) 536 into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the AI environment data 510 and output data 512 into the machine learning model one at a time. In some embodiments, the training of the machine learning model includes tuning the model to receive AI environment data 510 and output predictive data (e.g., predictions of network performance). The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

In some embodiments, data used to train (including initial training, updating, retraining, etc.) may be appropriate for use with some types of AI models, some types of input data, some types of decision making, etc., and not others. In some embodiments, training data and/or AI models trained with that data may be classified by a taxonomy for facilitating AI governance operations. Monitoring of training data and AI models may include monitoring of the taxonomy classifications, and one or more regulations may be enforced based on the monitoring of the AI data. In some embodiments, AI models including one or more classifications may produce data that also includes one or more classifications, which may be the same as the AI model taxonomy classifications or different than the AI taxonomy model classifications. For example, an AI model that includes a set of classifications, possibly in combination with input data that may have a different set of classifications, may produce output data that is tagged with a third set of classifications. In some embodiments, input data may be tagged with some severity of bias, untrustworthiness, or other desirable quality, and the AI model may similarly be tagged. Output data from the model based on the input data may generate output data that is automatically tagged with an upgraded or more severe form of the classification. In other embodiments, classifications from input data or AI models may be passed to output data, combinations of classifications in input and/or AI models classifications may cause classifications to be applied to the output data based on the input and model classifications, etc.

In some embodiments, output of an AI model may include one or more predictions or inferences. For example, an output prediction or inference may include summary data, indications of cellular network performance, recommended or initiated corrective actions, analysis of user equipment or other data sources, or the like. Processing logic may cause one or more updates to the cellular network based on the output. Processing logic may provide summary data to one or more northbound applications. Processing logic may provide requests for summary data to components of the network, such as a software defined data pipeline control module.

Processing logic may compare the generated output against a target output (e.g., a label corresponding to the “correct answer”) and determine whether a threshold criterion is met (e.g., threshold similarity between the generated output and target output). Processing logic determines an error (i.e., a classification error) based on the differences between the generated output and the target output. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria are met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

As an example, in one embodiment, a machine learning model (e.g., monitored by an AI governance function) is trained to determine predictive data (e.g., predicted updates to improve operations of a cellular network). A similar process may be performed to train machine learning models to perform other tasks such as those set forth above. A set of many (e.g., thousands to millions) sets of model input data may be collected and performance indicators may be determined based on the input data.

Once one or more trained machine learning models 538 are generated, they may be stored in model storage 545, and may be added to a cellular network, e.g., a processing device or data storage device associated with a target network function, or the like. The cellular network may then use the one or more trained ML models 538 as well as additional processing logic to implement an automatic mode, in which user manual input of information is minimized or even eliminated in some instances.

For model application workflow 517, according to one embodiment, input data 562 may be input into AI model 567, which may include a trained neural network. Based on the input data 562, AI model 567 outputs information indicating network performance, recommended corrective actions, enacting corrective actions, or the like. AI model 567 generates AI output data 569, which may include summary data, recommended actions, summary data requests, predicted root causes, or the like. AI output data 569 may include recommended or enacted network actions (e.g., to improve network performance), classification of data (e.g., classification of various AI input or training data into taxonomic classifications, classification of network data as normal or abnormal, etc.), or other data output by one or more AI models.

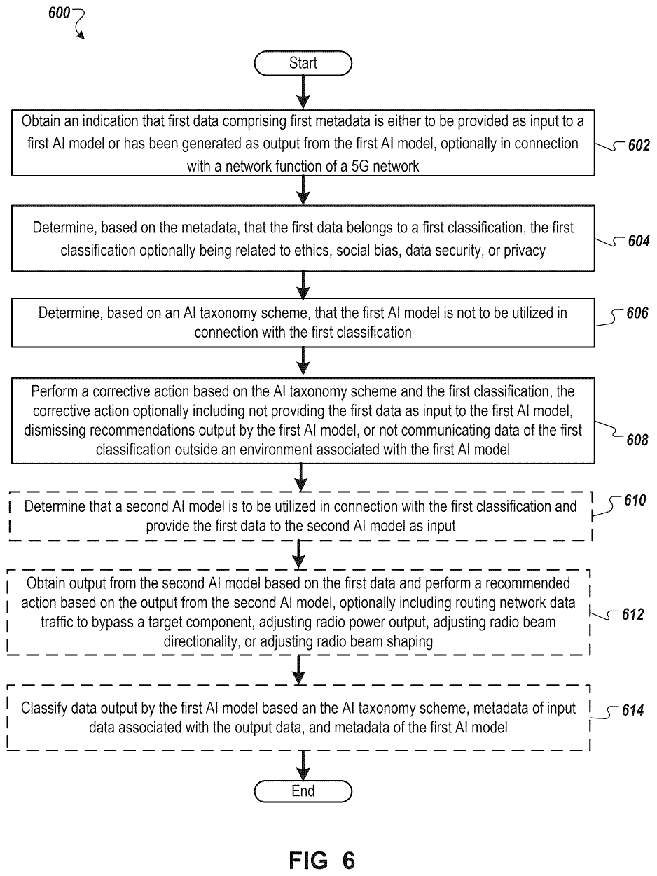

FIG. 6 is a flow diagram of method 600 associated with AI governance functions, according to certain embodiments. Method 600 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 600 may be performed, in part, by components of system 100. Method 600 may be performed by one or more processing devices executing AI governance function 108 of FIG. 1, etc. In some embodiments, a non-transitory machine-readable storage medium stores instructions that when executed by a processing device (e.g., associated with AI governance function 108, of system 100, etc.) cause the processing device to perform operations of method 600.

For simplicity of explanation, method 600 is depicted and described as a series of operations. However, operations in accordance with this disclosure can occur in various orders and/or concurrently and with other operations not presented and described herein. Furthermore, not all illustrated operations may be performed to implement method 600 in accordance with the disclosed subject matter. In addition, those skilled in the art will understand and appreciate that method 600 could alternatively be represented as a series of interrelated states via a state diagram or events.

FIG. 6 is a flow diagram of a method 600 for performing corrective actions recommended and/or instituted by AI governance based on data classification and taxonomy, according to some embodiments. At block 602, process logic obtains an indication that first data comprising metadata is either to be provided as input to a first AI model or has been generated as output from the first AI model. In some embodiments, the AI model exists within an AI environment, e.g., a connected set of functions or operations that include one or more AI models for performing one or more tasks. In some embodiments, the AI model is part of a cellular network, e.g., a 5G network. In some embodiments, the AI model may be executed by a network function of the 5G network, may be executed by a processing device of the 5G network, an AI agent interfacing with the AI model may be executed by a network function or processing device of the 5G network, or the like.

At block 604, process logic determines, based on the metadata, that the first data belongs to a first classification, the first classification optionally being related to ethics, social bias, data security, or privacy. The classification may include categorization based on a taxonomy scheme of interest. The classification may include multiple categories, e.g., a single selection of data may be classified in multiple different ways, which may interact differently with different AI models.

At block 606, process logic determines, based on an AI taxonomy scheme, that the first AI model is not to be utilized in connection with the first classification. In some embodiments, classification of the first data and AI model may be one-to-one, e.g., data that is sensitive to social bias may be completely excluded from operation with AI models to determine social outcomes (e.g., financial aid, loans, or the like). In some embodiments, an AI model may not be associated with the first data due to more complex relationships, e.g., first data that includes a first classification, includes a second classification, and does not include a third classification may be excluded from use with the AI model. These rules and relationships may be set up as part of the AI governance taxonomy by a subject matter expert, may be monitored for effectiveness and/or updated by an expert and/or by one or more monitoring models including AI models, etc. In some embodiments, the AI taxonomy may be machine-readable, e.g., a series of markers included in metadata of the data indicative of classifications. In some embodiments, AI taxonomy may be human-readable or have a human-readable directory that may be used for monitoring, reviewing, and/or adjusting taxonomy of data and/or AI models in the AI environment. Taxonomy upkeep and initiation may be performed with a human-in-the-loop, e.g., with the input of a subject matter expert.

At block 608, process logic performs a corrective action based on the AI taxonomy scheme and the first classification. The corrective action may include routing data away from the AI model, e.g., input data, training data, retraining data, or the like that does not match or correspond to intended uses of the AI model may not be delivered to the AI model. The corrective action may include adjusting actions based on the output of the AI model, e.g., not taking corrective actions, only taking corrective actions with a higher threshold of confidence or a lower threshold of risk than with a different set of associated taxonomic classifications, etc. The corrective action may include dismissing recommendations output by the AI model. The corrective action may include canceling, disabling, not allowing, or interrupting communication of data with another entity, e.g., another network function of a cellular network, a communication node in connection with a processing device outside the network architecture (e.g., a customer or vendor device), or the like.

In some embodiments, actions may be performed based on the AI taxonomy data that are not corrective. For example, discovering and classifying data consumed by AI may be included in actions performed in connection with method 600. Such discovery and classification (e.g., classification of AI output data based on training data and/or input data taxonomy) may be used for AI transparency, in case of AI data audit, or the like.

In some embodiments, performing the corrective action may include providing an alert to a user. In some embodiments, a dashboard may be provided in association with the AI environment (e.g., cellular network). The dashboard may be or include an AI governance element, may be or include a graphical user interface or other type of user interface, etc. The dashboard may alert a user (e.g., AI security professional, AI ethics professional, or other subject matter expert) that data in the AI environment is being used in a way which may not be in accordance with original intentions, which may be dangerous or lead to inaccurate or biased results, or the like. In some embodiments, actions may be taken by the AI governance system, which may be reported via the AI governance dashboard. In some embodiments, actions may be recommended by the AI governance system via the dashboard. In some embodiments, a hybrid approach may be enacted, e.g., a first action may be taken by the AI governance system and a second (e.g., further or more intrusive or extreme action) recommended via the dashboard. In some embodiments, a set of rules surrounding the AI taxonomy scheme may include, in addition to relations between whether data including particular tags or classifications are to be used in connection with particular AI models, actions to be recommended to a user, actions to be taken automatically, etc. Such actions based on combinations of input conditions (e.g., combinations of taxonomies associated with input data, output data, AI models, etc.) may be initiated by a subject matter expert, updated or adjusted, etc., in some embodiments via the AI governance dashboard. In some embodiments, a corrective action may include tagging output data of an AI model with one or more classifications in accordance with AI governance taxonomy, e.g., based on classification(s) of the input data and AI model. In some embodiments, the taxonomy scheme may include data relevance, which may be related to a data lifestyle (e.g., older data may be phased out of use in one or more AI models depending on requirements of the specific models). Corrective actions may include enabling data forensics; enabling entitlement management (e.g., monitoring and determining who or what functions have access to what data); documenting of AI usage and data consumption and generation; monitoring of deviations of behavior as AI models change, are updated and replaced, etc. ; upholding of data sharing agreements; data lifecycle management; codifying of written AI policy; etc.

At block 610, process logic optionally determines that a second AI model is to be utilized in connection with the first classification. Process logic may enable providing the first data to the second AI model as input, may enable utilizing recommendations included in or based on the first data in association with the second AI model to be implemented, etc. In some cases, the AI environment (e.g., 5G network) may include many AI models, at least some of which are monitored by the AI governance function (which may include monitoring data input, the models themselves, training data, data output, etc.). The AI governance function may enforce rules, guidelines, updates, or the like to any or all of the AI models included in the AI environment (e.g., 5G network).

At block 432, process logic optionally obtains output from the second AI model based on the first data and performs a recommended action based on the output of the second AI model. The recommended action may be related to adjusting network operations of a 5G cellular network. The recommended action may include adjusting data flow, adjusting network function responsibilities, adjusting operations of virtual computing devices, adjusting data flow or processing resource allocation, etc. The recommended action may include rerouting network data traffic to bypass a target (e.g., overworked, malfunctioning, under service or repair, etc.) component of the network. The recommended action may include adjusting radio output, including power output, beam shaping, beam directionality, etc. In some embodiments, network traffic may be routed based on AI direction to accomplish some network goal, such as separating traffic from one entity (e.g., a private network) from other data (e.g., the public network). Network traffic may be routed based on AI into different network slices to accomplish one or more network goals, such as ultra low latency for some critical application (e.g., emergency services, autonomous vehicles, etc.).

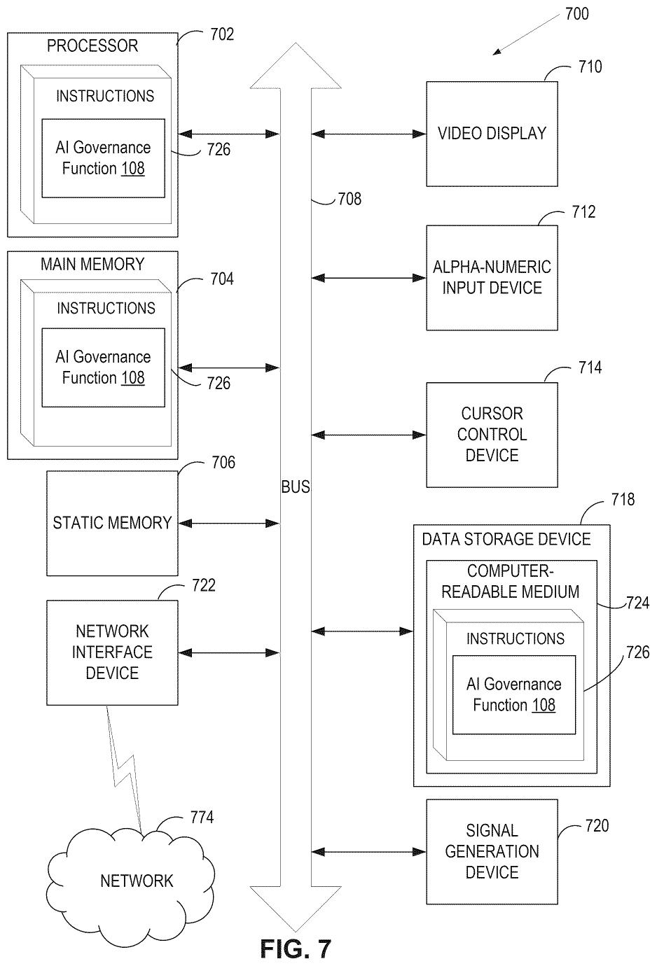

FIG. 7 is a block diagram illustrating a computer system 700, according to some embodiments. In some embodiments, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 718, which may communicate with each other via a bus 708.

Processing device 702 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 may further include a network interface device 722 (e.g., coupled to network 774). Computer system 700 also may include a video display unit 710 (e.g., an LCD), an alphanumeric input device 712 (e.g., a keyboard), a cursor control device 714 (e.g., a mouse), and a signal generation device 720.

In some embodiments, data storage device 718 may include a non-transitory computer-readable storage medium 724 (e.g., non-transitory machine-readable medium, non-transitory machine-readable storage medium, or the like) on which may store instructions 726 encoding any one or more of the methods or functions described herein, including instructions encoding components of FIG. 1 (e.g., AI governance function 108, etc.) and for implementing methods described herein. The non-transitory machine-readable storage medium may store instructions which are used to execute methods related to modeling gas dynamics of a process chamber, adjusting processing system operations to improve substrate processing operations, reducing gas backflow to reduce particle deposition, or the like.

Instructions 726 may also reside, completely or partially, within volatile memory 704 and/or within processing device 702 during execution thereof by computer system 700, hence, volatile memory 704 and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
obtaining an indication that first data comprising metadata is either to be provided as input to a first artificial intelligence (AI) model or has been generated as output from the first AI model;
determining, based on the metadata, that the first data belongs to a first classification;
determining, based on an AI taxonomy scheme, that the first AI model is not to be utilized in connection with the first classification; and
performing a corrective action based on the AI taxonomy scheme and the first classification.

2. The method of claim 1, wherein a network function of a 5G network comprises an AI agent for interfacing with the first AI model.

3. The method of claim 1, wherein the first data is to be provided as input to the first AI model, and the corrective action comprises adjusting data delivery to the first AI model such that the first data is not provided as input to the first AI model, and wherein the method further comprises:
determining, based on the AI taxonomy scheme, that a second AI model is to be utilized in connection with the first classification; and
providing the first data to the second AI model as input.

4. The method of claim 3, further comprising:
obtaining output from the second AI model based on the first data; and
performing a recommended action based on the output from the second AI model, wherein the recommended action is associated with operations of a cellular network.

5. The method of claim 4, wherein the recommended action comprises one or more of:
routing network data traffic to bypass a target component;
adjusting radio power output;
adjusting radio beam directionality; or
adjusting radio beam shaping.

6. The method of claim 1, wherein the first classification corresponds to a data deficiency related to social bias, and wherein the corrective action comprises providing instructions to a processing device to dismiss recommendations from the first AI model in connection with the first data.

7. The method of claim 1, wherein the first classification corresponds to data security, and wherein the first data has been generated as output from the first AI model, and wherein the corrective action comprises instructing a processing device to not transmit the first data to any device external to a cellular network associated with the first AI model.

8. The method of claim 1, wherein the first AI model is one of a plurality of AI models, and wherein the method further includes:
obtaining a plurality of indications related to a plurality of data based on the AI taxonomy scheme; and
determining whether to perform corrective actions in association with each of the plurality of data and plurality of AI models based on the AI taxonomy scheme.

9. The method of claim 1, wherein the first data is provided as input to the first AI model, wherein the method further comprises:
obtaining second data based on the first data as output from the first AI model;
determining a second classification based on the first classification and a third classification associated with the first AI model; and
applying the second classification to the second data by amending metadata of the second data.

10. One or more non-transitory, computer-readable storage media having computer-readable instructions thereon which, when executed by one or more processing devices, cause the one or more processing devices to perform operations comprising:
obtaining an indication that first data comprising metadata is either to be provided as input to a first artificial intelligence (AI) model or has been generated as output from the first AI model;
determining, based on the metadata, that the first data belongs to a first classification;
determining, based on an AI taxonomy scheme, that the first AI model is not to be utilized in connection with the first classification; and
performing a corrective action based on the AI taxonomy scheme and the first classification.

11. The one or more non-transitory, computer-readable storage media of claim 10, wherein a network function of a 5G network comprises an AI agent for interfacing with the first AI model.

12. The one or more non-transitory, computer-readable storage media of claim 10, wherein the first data is to be provided as input to the first AI model, and the corrective action comprises adjusting data delivery to the first AI model such that the first data is not provided as input to the first AI model, and wherein the operations further comprise:
determining, based on the AI taxonomy scheme, that a second AI model is to be utilized in connection with the first classification; and
providing the first data to the second AI model as input.

13. The one or more non-transitory, computer-readable storage media of claim 12, wherein the operations further comprise:
obtaining output from the second AI model based on the first data; and
performing a recommended action based on the output from the second AI model, wherein the recommended action is associated with operations of a cellular network.

14. The one or more non-transitory, computer-readable storage media of claim 13, wherein the recommended action comprises one or more of:
routing network data traffic to bypass a target component;
adjusting radio power output;
adjusting radio beam directionality; or
adjusting radio beam shaping.

15. The one or more non-transitory, computer-readable storage media of claim 10, wherein the first classification corresponds to a data deficiency related to social bias, and wherein the corrective action comprises providing instructions to a processing device to dismiss recommendations from the first AI model in connection with the first data.

16. A system comprising memory and a processing device coupled to the memory, wherein the processing device is configured to:
obtain an indication that first data comprising metadata is either to be provided as input to a first artificial intelligence (AI) model or has been generated as output from the first AI model;
determine, based on the metadata, that the first data belongs to a first classification;
determine, based on an AI taxonomy scheme, that the first AI model is not to be utilized in connection with the first classification; and
perform a corrective action based on the AI taxonomy scheme and the first classification.

17. The system of claim 16, wherein a network function of a 5G network comprises an AI agent for interfacing with the first AI model.

18. The system of claim 16, wherein the first data is to be provided as input to the first AI model, and the corrective action comprises adjusting data delivery to the first AI model such that the first data is not provided as input to the first AI model, and wherein the processing device is further configured to:
determine, based on the AI taxonomy scheme, that a second AI model is to be utilized in connection with the first classification; and
providing the first data to the second AI model as input.

19. The system of claim 18, wherein the processing device is further configured to:
obtain output from the second AI model based on the first data; and
perform a recommended action based on the output from the second AI model, wherein the recommended action is associated with operations of a cellular network.

20. The system of claim 18, wherein the recommended action comprises one or more of:
routing network data traffic to bypass a target component;
adjusting radio power output;
adjusting radio beam directionality; or adjusting radio beam shaping.
